(19) United States
(12) Patent Application Publication
(10) Pub. No.: US 2014/0337883 A1
(43) Pub. Date: Nov. 13, 2014

(54) METHOD AND APPARATUS FOR NETWORKING MEDIA CONTENT CONSUMPTION STATUS IN A GROUP OF USERS

(71) Applicant: Evan Michael Foote, Appleton, WI (US)

(72) Inventor: Evan Michael Foote, Appleton, WI (US)

(73) Assignee: Thomson Licensing, Issy de Moulineaix (FR)

(21) Appl. No.: 14/360,975

(22) PCT Filed: Dec. 13, 2011
(86) PCT No.: PCT/US2011/064540

§ 371 Date: May 28, 2014

(51) Int. Cl. H04N 21/488; H04N 21/81; H04N 21/61; H04N 21/4788; H04N 21/442

(52) U.S. Cl. CPC H04N 21/4882; H04N 21/4788; H04N 21/44222; H04N 21/6125; H04N 21/6175; H04N 21/8126
USPC 725/34

(57) ABSTRACT

A method and apparatus for exchanging media content consumption characteristics in a network is described. The method includes receiving input data, the input data indicating that a first user in a user group has changed a content consumption characteristic, determining if the first user's changed content consumption characteristic is based a content consumption characteristic of a second user in the user group, and generating a message, the message including information indicating that the first user's changed content consumption characteristic is based on the content consumption characteristic of the second user in the user group. The apparatus includes a transceiver circuit that is coupled to the network and a controller circuit that receives input data from the first user, further determines if the first user's change is based on input data received through the transceiver circuit from the second user, and further generates the message that is provided.

### TECHNICAL FIELD OF THE INVENTION

The present disclosure generally relates to digital content systems and the Internet, and more particularly, to an apparatus and method for networking media content client devices by linking users together as a user group in order to allow the users to monitor content consumption status (e.g., program viewing) of other users in the group and to allow content recommendations to users in the group.

### BACKGROUND OF THE INVENTION

The world of the Internet and the world of video entertainment continue to merge, forming the potential for many new opportunities in structures, devices and applications. Many of these applications may be capable of providing improved convenience of one or more of the activities associated with the Internet, when coupled with a video entertainment device, such as a set-top box (STB) or television. One such application is the ability to network users of video entertainment devices together.

Many social based Internet networking uses, such as microblogging, chatting, or instant messaging, revolve around remaining in contact with others in the network or group, while carrying on other activities. Social based networking interfaces typically include separate devices often geared towards networking applications (e.g., smart phones or personal computers). However, people may also wish to interact in a social network as a part of another entertainment experience (e.g., while watching a television program or while watching a movie in their home).

Therefore, a need exists for providing communications and interfaces between users in a group while at least some of the users in the group are engaged in activities (e.g., viewing entertainment programs). The communications and interfaces further allowing an exchange of information related to a user's program viewing status.

### SUMMARY

According to an aspect of the present disclosure, a method for networking the content consumption characteristics of users in a user group is described. The method includes receiving input data, the input data indicating that a first user in a user group has changed a content consumption characteristic, determining if the first user's changed content consumption characteristic is based a content consumption characteristic of a second user in the user group, and generating a message that is provided to at least one other user in the user group, the message including information indicating that the first user's changed content consumption characteristic is based on the content consumption characteristic of the second user in the user group.

According to another aspect of the present disclosure, an apparatus for networking the program viewing characteristics of users in a user group is described. The apparatus includes a transceiver circuit that is coupled to a network, the network interfacing a plurality of users in a user group, and a controller circuit coupled to the transceiver circuit, the controller circuit receiving input data from a first user, the input data indicating that the first user has changed a content consumption characteristic, the controller circuit further determining if the first user's change in content consumption characteristic is based on input data received through the transceiver circuit from a second user, the second user's input data indicating a content consumption characteristic of the second user, the controller circuit further generating a message that is provided to at least one other user in the user group, the message including information indicating that the first user's changed content consumption characteristic is based on the content consumption characteristic of a second user in the user group.

### BRIEF DESCRIPTION OF THE DRAWINGS

These, and other aspects, features, and advantages of the present disclosure will be described or become apparent from the following detailed description of the preferred embodiments, which is to be read in connection with the accompanying drawings.

In the drawings, wherein like reference numerals denote similar elements throughout the views:

FIG. 1 is a block diagram of an exemplary system for delivering video content and interfacing network related services to users in accordance with the present disclosure;

FIG. 2 is a block diagram of an exemplary host device in a user's premises in accordance with the present disclosure;

FIG. 3 is a perspective view of an exemplary remote controller in accordance with an embodiment of the present disclosure;

FIG. 4 is a perspective view of a touch panel device in accordance with the present disclosure;

FIG. 5 is a flowchart of an exemplary process for linking status messages from users in a network in accordance with an embodiment of the present disclosure;

FIG. 6 is a flowchart of another exemplary process for processing status notification events in accordance with an embodiment of the present disclosure;

FIG. 7 is a flowchart of an exemplary process for processing external notification events in accordance with an embodiment of the present disclosure;

FIG. 8 is a flowchart of an exemplary process for processing internal notification events in accordance with an embodiment of the present disclosure;

FIGS. 9A-9C are a set of display images of an exemplary user interface for status communications in accordance with an embodiment of the present disclosure;

FIG. 10 is a display image of another exemplary user interface for status communications in accordance with another embodiment of the present disclosure;

FIG. 11 is a display image of a further exemplary user interface for status communications in accordance with another embodiment of the present disclosure; and

FIG. 12 is an event timeline of exemplary set of events for a set of users in a user group in accordance with an embodiment of the present disclosure.

It should be understood that the drawing(s) are for purposes of illustrating the concepts of the disclosure and is not necessarily the only possible configuration for illustrating the disclosure.

### DETAILED DESCRIPTION OF PREFERRED EMBODIMENTS

It should be understood that the elements shown in the figures may be implemented in various forms of hardware, software or combinations thereof. Preferably, these elements are implemented in a combination of hardware and software on one or more appropriately programmed general-purpose devices, which may include a processor, memory and input/output interfaces. Herein, the phrase “coupled” is defined to mean directly connected to or indirectly connected with through one or more intermediate components. Such intermediate components may include both hardware and software based components.

The present description illustrates the principles of the present disclosure. It will thus be appreciated that those skilled in the art will be able to devise various arrangements that, although not explicitly described or shown herein, embody the principles of the disclosure and are included within its spirit and scope.

All examples and conditional language recited herein are intended for educational purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, read only memory (ROM) for storing software, random access memory (RAM), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

The present disclosure relates to an apparatus and method that allows users in a group to display and enter messages related to one or more characteristics of their content consumption activities and status. The apparatus and method include networking the group of users through a networking structure, program, webservice, or website, using a device connected to the Internet. The messages are entered and displayed on a video display (e.g., a television, touch panel device, or computer monitor) through a connection to the Internet enabled host or client device (e.g., a set-top box or gateway). The host or client device is also capable of outputting an audio or video content signal delivered through a video broadcast network, such as a cable, terrestrial, or satellite broadcast network, to the display device. Initially, embodiments for delivering various types of content to a user will be described according to aspects of the present disclosure. Subsequently, a user interface (UI) and method for displaying and posting content (e.g., messages) related to television program viewing status within a group of users in accordance with embodiments of the present disclosure will then be detailed. The UI content is generated, managed, and output through the client device and is provided for display on the video display in a box or overlay on the screen while program video is playing. Further, the UI content may be displayed on a touch panel device operating as a second video display screen. In addition and if appropriate the user interface may prompt a user for responses based on the displayed content or messages.

Although one or more of the embodiments of the present disclosure described below is primarily focused on media content consumption associated with television video programs or channels, it is important to note that the present disclosure may also apply to other forms of content usage and consumption. For instance, aspects of the present disclosure may be applied to the listening of audio content from content sources such as radio stations. Further, aspects of the present disclosure may also apply to networked gaming systems and services or to other content consumed through sources other than broadcast delivery sources (e.g., Internet or local content delivery sources).

In order to provide a high value service to end users, it is desirable for a content delivery system to provide information related to activities and program viewing of others (e.g., friends or others sharing a common interest). Providing such information has been made more popular, and functionally easier to accomplish, as a result of networking sites and activities on the Internet, (e.g., social networking websites services). As networking between users (e.g., social networking) on the Internet becomes more and more popular, new posting and viewing mechanisms are needed. The present disclosure describes embodiments for displaying and posting activity updates (e.g., messages) related to program viewing and further to provide links based on viewing habits that become common between friends in the network. Such a process may be termed “viral tuning” and results from the phenomenon that if only a first user is viewing a program, maybe other users in the group will be reluctant to, or may not yet be interested in also tuning in to the program. However, once a second user, a third user, or even a particular user, has also begun viewing the program, the other users in the group may be more likely to also tune in to the program. The embodiments below also describe client devices (e.g., settop boxes, gateways, display devices, and televisions) that function to allow users to link to each other in order to allow status updates related to viewing to be passed between users in a user group.

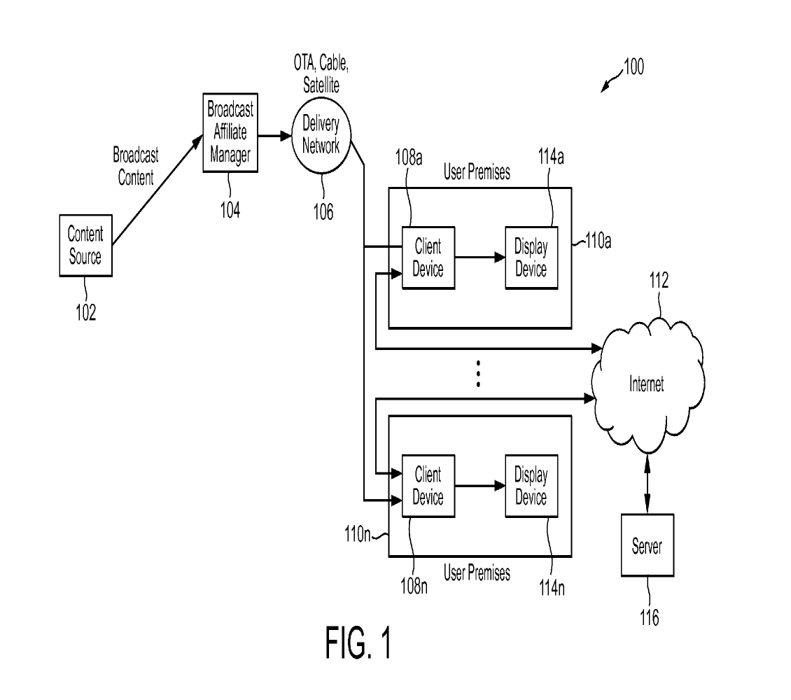

Turning now to FIG. 1, a block diagram of an embodiment of a system 100 for delivering content to a home or end user is shown. System 100 provides content, data, and services through one or more networks, and further permits communication between a plurality of users over a network. A content source 102 is connected broadcast affiliate manager 104. Broadcast affiliate manager 104 is connected to delivery network 106. Delivery network 106 is connected to a plurality of client devices 108a-108n at user premises 110a-110n. The plurality of client devices 108a-108n are connected to display devices 114a-114n. Each of the client devices 108a-108n is also connected to the Internet network 112. A server 116 is also connected to the Internet 112.

The content originates from a content source 102, (e.g., a movie studio or production house. The content may be supplied in at least one of two forms. One form may be a broadcast form of content. The broadcast content is provided to the broadcast affiliate manager 104, which is typically a national broadcast service, such as the American Broadcasting Company (ABC), National Broadcasting Company (NBC), Columbia Broadcasting Systems (CBS), etc. The broadcast affiliate manager may collect and store the content, and may schedule delivery of the content over a deliver network, delivery network 106. Delivery network 106 may include satellite link transmission from a national center to one or more regional or local centers. Delivery network 106 may also include local content delivery using local delivery systems such as over the air broadcast, satellite broadcast, or cable broadcast. The locally delivered content is provided to a number of user premises 110a-110n. Located at each of the user premises 110a-110n is a client device 108a-108n. The client device 108a-108n is further connected to a display device 114a-114n, where the content will subsequently be displayed to the user.

In addition to the broadcast delivery system, client device 108a-108n at each user premises 110a-110n is connected to the Internet 112. The communication connection to the Internet 112 may include high-speed broadband type communications systems. A user may obtain content and data directly from the Internet 112 without necessarily having the content managed by the broadcast affiliate manager 104. For example, the user may obtain content and data from web sites hosted on various servers, such as server 116, where the servers are coupled to the Internet 112. In one embodiment, server 116 hosts a social networking Internet web site that allows a group of users to interact based on, for instance, the viewing of content delivered over the broadcast delivery network 106. Server 116 may include a network communications processor, memory for storing information and operational code, and network transmission and reception interfaces in order to properly operate and host web services and networking sites.

Client device 108a-108n includes an interface to both the broadcast delivery network 106 and an interface to the broadband delivery network 112, e.g., the Internet. As a result, client device 108a-108n allows an over-the-top interface to interact with services, such as the social networking services on an Internet site or web services located on server 116. Client device 108a-108n may be a cable STB, Internet protocol (IP) STB, or satellite STB with each capable of including an application interface to a social networking client for an Internet site. The client device 108a-108n may also be, but is not limited to, a computer device, tablet, gateway, display device, television, wireless phone, personal digital assistant (PDA), computers, gaming platform, remote control, multi-media player, or home networking appliance that includes both broadcast and Internet interfaces, and may further include a storage media for digital video recording.

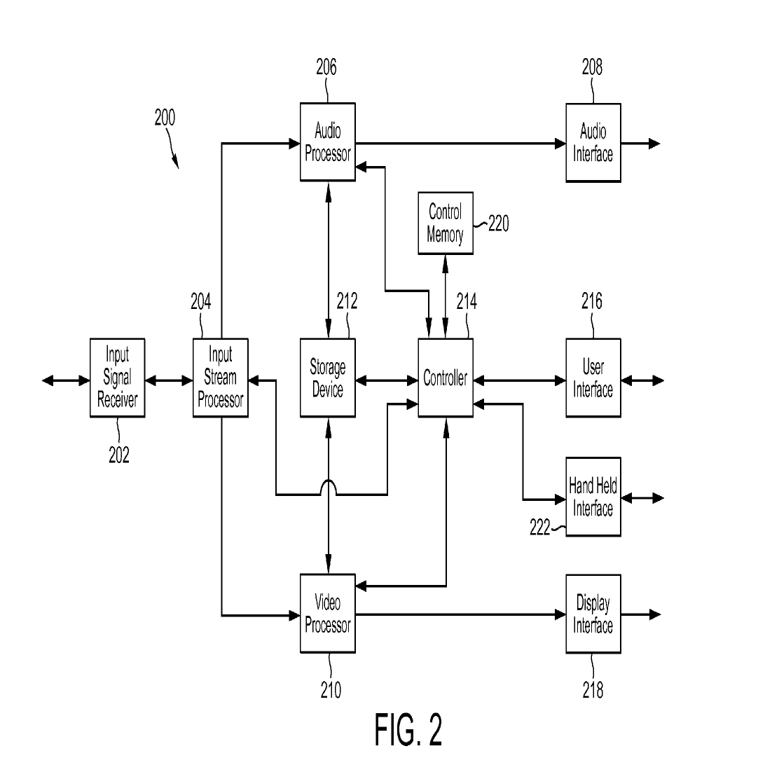

The client devices 108a-108n may receive different types of content from one or both of delivery network 106 and the Internet 112. The client devices 108a-n process the content, and provides a separation of the content based on user preferences and commands. The client devices 108a-108n may also include a storage device, such as a hard drive or optical disk drive, for recording and playing back audio and video content. Further details of the operation of the client devices 108a-108n and features associated with playing back stored content will be described below in relation to FIG. 2.

The processed content from client devices 108a-108n is provided to display devices 114a-114n. The display devices 114a-114n may be conventional two-dimensional (2-D) type displays or may alternatively be advanced three-dimensional (3-D) type displays. It should be appreciated that other devices having display capabilities including, but not limited to, computer devices, tablets, gateways, display devices, televisions, wireless phones, PDAs, computers, gaming platforms, remote controls, multi-media players, home networking appliances or the like, may employ the teachings of the present disclosure and are considered within the scope of the present disclosure.

System 100 provides the networking and communications capability for connecting users together as groups, principally through the use of client devices 108a-108n as well as the Internet 112 and, if necessary, server 116. In one embodiment, a group of users sharing some common interest, such as television viewing, is determined, identified, and/or formed. The group of users may be networked together for the purpose of sharing television program viewing status as well as for other possible reasons, such as school or professional affiliation. As a result of a user in the group viewing television program content delivered over delivery network 106, a change, such as a channel change is detected and identified with respect to the viewing status of the user. The change may be detected automatically or may be user identified through a message prompt. Information related to the viewing status change is sent to the remaining users of the group. As a result of this status change message, a change is detected in the viewing status of a second user (either user identified or automatically). This second status change prompts the sending of an updated notification message from the second user including the information about the viewing status change of the first user.

Turning now to FIG. 2, a block diagram of an embodiment of the core of a client device 200 is shown. Except as described below, the client device 200 operates in a manner similar to client devices 108a-108n described in FIG. 1. The device 200 shown may also be incorporated into other systems including the display device, such as display devices 114a-114n. In either case, several components necessary for complete operation of the client device 200 are not shown in the interest of conciseness, as the components not shown are well known to those skilled in the art.

Signals are interfaced to device 200 at input signal receiver 202. Input signal receiver 202 connects to input stream processor 204. The input stream processor connects to audio processor 204 and video processor 210. Audio processor 206 connects to audio interface 208, which provides the audio output signal from device 200. Video processor 210 connects to display interface 218, which provides the video output signal from device 200. Audio processor 206 and video processor 210 also connect to a storage device 212. A controller 214 connects to the storage device 212, as well as input stream processor 204, audio processor 206, and video processor 210. A control memory 220 connects to the controller 214. Controller 214 also connects to user interface 216 and handheld interface 222.

In the device 200, the content and data is received in an input signal receiver 202. The input signal receiver 202 may be one or more of several known receiver circuits used for receiving, demodulation, and decoding signals provided over one of the several possible networks including over the air, cable, satellite, Ethernet, fiber and phone line networks. The desired input signal(s) may be selected and retrieved in the input signal receiver 202 based on user input provided through a control interface (not shown). It is to be appreciated that the input signal receiver 202 may, in certain embodiments, be a transceiver for two way communication to and from device 200. In some embodiments the transceiver will output information, such as a search request to a network (e.g., Internet 112 described in FIG. 1) to search for Internet content. In other embodiments the transceiver may be configured to connect and interact with a networking website (e.g., social networking website) to send and receive networking messages.

The decoded output signal from the input signal receiver 202 is provided to an input stream processor 204. The input stream processor 204 performs the final signal selection and processing. The processing includes separation of video content from audio content for the content stream. The audio content is provided to an audio processor 206 for conversion from the received format (e.g., a compressed digital signal) to another format (e.g., an analog waveform signal). The analog waveform signal is provided to an audio interface 208 and further to the display device 114 or an audio amplifier (not shown). Alternatively, the audio interface 208 may provide a digital signal to an audio output device or display device using a High-Definition Multimedia Interface (HDMI) cable or alternate audio interface such as via a Sony/Philips Digital Interconnect Format (SPDIF). The audio processor 206 also performs any necessary conversion for the storage of the audio signals.

The video output from the input stream processor 204 is provided to a video processor 210. The video signal may be one of several formats. The video processor 210 provides, as necessary a conversion of the video content, based on the input signal format. The video processor 210 also performs any necessary conversion for the storage of the video signals.

A storage device 212 stores audio and video content received at the input. The storage device 212 allows later retrieval and playback of the content under the control of a controller 214 and also based on commands, e.g., navigation instructions such as fast-forward (FF) and rewind (Rew), received from a user interface 216. The storage device 212 may be a hard disk drive, one or more large capacity integrated electronic memories, such as static RAM (SRAM), or dynamic RAM (DRAM), or may be an interchangeable optical disk storage system such as a compact disk drive or digital video disk drive.

The converted video signal, from the video processor 210, either originating from the input or from the storage device 212, is provided to the display interface 218. The display interface 218 further provides the display signal to a display device of the type described above. The display interface 218 may be an analog signal interface such as red-green-blue (RGB) or may be a digital interface such as HDMI. It is to be appreciated that the display interface 218 will generate the various screens for presenting the search results or message in an overlay as will be described in more detail below.

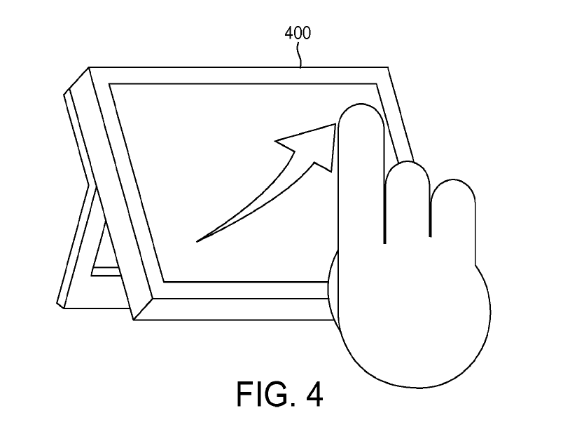

The controller 214 is interconnected via a bus to several of the components of the device 200, including the input stream processor 202, audio processor 206, video processor 210, storage device 212, and a user interface 216. The controller 214 manages the conversion process for converting the input stream signal into a signal for storage on the storage device or for display. The controller 214 also manages the retrieval and playback of stored content. Furthermore, as will be described below in relation to FIG. 4, the controller 214 performs searching of content, either stored or to be delivered via the delivery networks described above. The controller 214 is further communicatively connected, or coupled, to control memory 220 (e.g., volatile or nonvolatile memory, including RAM, SRAM, DRAM, ROM, programmable ROM (PROM), flash memory, electronically programmable ROM (EPROM), electronically erasable programmable ROM (EEPROM), etc.) for storing information and instruction code for controller 214. Further, the implementation of the memory may include several possible embodiments, such as a single memory device or, alternatively, more than one memory circuit communicatively connected, or coupled, together to form a shared or common memory. Still further, the memory may be included with other circuitry, such as portions of bus communications circuitry, in a larger circuit.

In addition to interfacing to a user interface element and a display device, client device 200 may also interface to a handheld device, such as a tablet through handheld interface 222. This handheld device may include a display screen with additional controls or may include a touch screen. In operation, the handheld device may function as a second screen, allowing additional content, such as on screen display windows and messages to be displayed to the user without interrupting or obscuring the viewing of the main display device. Video signals from video processor 210 as well as other data, such as the on screen display messages and message prompt returns, may be routed between controller 214 and handheld interface 222. Handheld interface 222 may transmit and receive signals and data with a handheld device or tablet using a radio frequency communications link, such as Wi-Fi, Bluetooth, or the Institute of Electrical and Electronics Engineers (IEEE) standard 802.11. Handheld interface 222 may alternatively transmit and receive signals and data with a handheld device or tablet using an infra-red interface.

To operate effectively, the user interface 216 of the present disclosure employs an input device that moves a cursor around the display. In one embodiment, the input device is a remote controller, with a form of motion detection, such as a gyroscope or accelerometer, which allows the user to move a cursor freely about a screen or display. In another embodiment, the input device is a controller in the form of a touch pad device or other touch sensitive device that will track the user's movement on the pad, and display it on the screen. In yet another embodiment, a conventional remote control device having navigational buttons may be used.

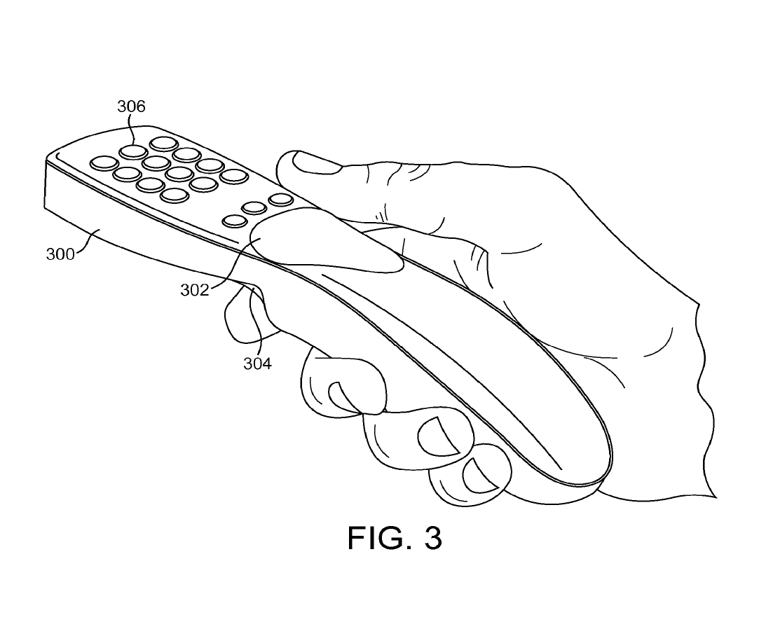

An exemplary hand-held angle-sensing remote controller 300 is illustrated in FIG. 3. Remote controller 300 includes a thumb button 302, positioned on the top side of controller 300 so as to be selectively activated by a user's thumb. Activation of thumb button 302 will also be referred to as a “click,” a command often associated with activation or launch of a selected function. Controller 300 further includes a trigger button 304, positioned on the bottom side of controller 300 so as to be selectively activated by a user's index (or “trigger”) finger. Activation of trigger button 304 will also be referred to as a “trigger,” and angular movement (i.e. pitch, yaw and/or roll) of the controller 300 while the trigger is depressed will be referred to as a “trigger-drag.” A trigger-drag command is often associated with movement of a cursor, virtual cursor or other indication of the user's interactive position on the display, such as a change of state (i.e., a highlighted or outlined cell), and is commonly used to navigate in and select entries from the interactive display. Additionally, a plurality of buttons 306 are provided for entering numbers and/or letters. In one embodiment, the plurality of buttons 306 is configured similar to a telephone-type keypad.

The use of a hand-held angle-sensing remote controller provides for a number of types of user interaction. When using an angle-sensing controller, changes in yaw map to left-and-right motions, changes in pitch map to up-and-down motions and changes in roll map to rotational motions along a longitudinal axis of the controller. These inputs are used to define gestures and the gestures, in turn, define specific contextual commands. As such, a combination of yaw and pitch can be used to define any two-dimensional motion, such as a diagonal, and a combination of yaw, pitch and roll can be used to define any three-dimensional motion.

An exemplary touch panel device 400 is illustrated in FIG. 4. Touch panel device 400 may be interfaced via the user interface 216 and/or handheld interface 222 of the client device 200, as shown in FIG. 2. The touch panel device 400 may be a stand-alone device (e.g., a tablet or touch display monitor). Alternatively, the touch panel device 400 may be incorporated into another device, such as a receiving device (e.g., client device 200 or gateway) or a remote control (e.g., remote controller 300). The touch panel device 400 allows operation of the client device 200 based on hand movements, or gestures, and actions translated through the panel into commands for the client device 200. In one embodiment, the touch panel device 400 may simply serve as a navigational tool to navigate the user interface. In other embodiments, the touch panel device 400 may additionally serve as a second display device allowing the user to more directly interact with the navigation by display messages and content related to the user interface and the present disclosure.

As described previously, the client device 200 is interfaced with a head end device located in a broadcast content delivery network, e.g., a cable network, as well as the Internet. The host device 200 receives program content, such as television programs and movies, from the head end device over the broadcast network. A software application may reside on the host device 200 for providing an interface, to applications related to networking on the Internet, such as the network applications described in the present disclosure. In some embodiments, the software application may be pre-loaded on the host device 200. In other embodiments, the host device may receive a downloadable software application as a client service to the host device 200 from the head end device or alternatively a website or server (e.g., server 116 described in FIG. 1). The application provides the interface for the social networking service provided over the Internet. It is important to note that the physical Internet interface may be over the same cable or medium that the video content from the head end is provided.

It is to be appreciated that the host device 200 includes an operating system and/or a micro instruction code. The various processes and functions described herein may either be part of the micro instruction code or part of the software application (or a combination thereof) which is executed via the operating system. In one embodiment, the software application is tangibly embodied on a program storage device, which may be uploaded to and executed by any type of client or host device, such as a set top box or digital video recorder.

The software application may be written in any programming language, such as Java language. The application may be pre-loaded or downloaded (e.g., for instance from the server or Internet site), and stored in a memory of the host device. It is to be appreciated that in one embodiment the memory is control memory 220 of FIG. 2 where the instructions stored thereon are executed by controller 214. In another embodiment, the memory and a corresponding processor or controller to perform the processing according to the present disclosure may be integrated into a separate, stand-alone integrated circuit such as a digital processing processor (DSP) or an application specific integrated circuit (ASIC). Table 1 describes an exemplary set of user commands, used as part of the user interface. Table 1 also describes an exemplary set of Network Interface commands sent to, and received by, the client devices that may be used in an embodiment of the software application.

TABLE I

| User Command | Feature |
|---|---|
| Log In | Option of starting or identifying and joining a user group |
| Active | Automatically accesses webservice or provides access |
| | to user group over network |
| Log Out | Currently not viewing programs or opting out of user |
| | group |
| Group | Allows user to select a group from a list of groups |
| Display | Fits text on screen based on words and lines rather than |
| | absolute position |
| | Shows time as how long ago rather than absolute “posted |
| | at this time” |
| Message | Allow user to change text size, spacing and position |
| Settings | Allow user to change text color |
| | Allow user to set time zone |
| | Allow user to log into or out of a group |
| | Allow user to change auto updates |
| | Allow user to change message display settings (e.g., |
| | hide, conditionally hide) |
| | Allow user to change box position based on television |
| Network | |
| Interface | Description |
| Ack | Acknowledge receipt and/or viewing of message |
| NAck | Message received, no acknowledgment by user |
| VT | Viral tuning event identified, user tuned channel as |
| | result of event message |
| Chan | Channel currently tuned |
| UP/DOWN | Channel up or down event occurred |
| REC | User making recommendation |
| Log in/Log out | User logging or logging out |
| Chan Surf | User currently channel surfing |
| Chan Hop | User currently switching between channels (channel list |
| | included) |
| Tune | Channel Tune event by user (includes number) |
| User | Identifies source of event message (includes identifier) |
| Program | Identifies Program by type, name, etc |
| “text” | Additional information, such as program name |

The software application, along with processes and user interfaces described below, allows a user to follow the program viewing status and habits of other users in a user group based on the viral tuning related status messages provided to the user group. The software application, along with the processes and user interfaces, also allow a user to provide updates to other users in the group as to his/her current viewing status or habits. These updates may further contribute to, or initiate, a viral tuning string of status messages sent between the users of the group.

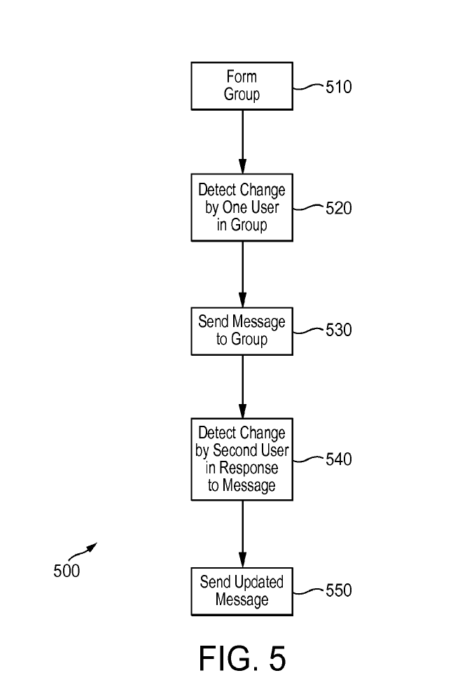

Turning now to FIG. 5, a flow chart of an exemplary embodiment of a process 500 for linking communication or notification status messages related to television or program viewing habits or status of users in a group according to aspects of the present disclosure is shown. Process 500 will primarily be described with respect to the elements in FIG. 1, such as client devices 108a-108n, Internet 112, and server 116. In some embodiments, all of the steps in process 500 may be performed in a single network connected device, such as server 116. However, one or more of the steps in process 500 may be equally applicable to device 200 described in FIG. 2. Furthermore, it is understood that the steps in process 500 rely on communications delivered from a broadcast network source, such as delivery network 106, as well as from a secondary network, such as delivery network 112, both described in FIG. 1. Further, it is important to note that some of the steps described in process 500 may be implemented more than once, or may be implemented recursively. Such modifications may be made without any effect to the overall aspects of process 500.

At step 510, a group of two or more friends, as users and television viewers, is determined, identified, and/or formed. The group of friends, or users, may be linked, connected, or networked together to form a user group for at least the purpose sharing television program viewing status. The users may also be linked based on other criteria, such as geographic or demographic conditions. This group of users may be determined and identified using a peer to peer contact process, such as direct interaction between two or more client devices 108a-108n through Internet 112. The group of users may also be established through the common use of a website or webservice that interfaces two or more client devices 108a-108n with a server 116. In one embodiment, a group of users subscribes to a social networking web service through server 116 and identifies each other as friends, thereby establishing a group in the web service. As a result of the social networking service, the group of users or friends chooses to share television viewing status information with each other. It is important to note that a user may also subscribe to or join more than one user group.

At step 520, during the time that one or more users in the group identified in step 510 is viewing television program content delivered over delivery network 106, a change is detected and identified with respect to the viewing status of one of the users in the identified group. The change is detected or determined by the one user's client device (e.g., STB or computer device). The status change may be a channel change or a program guide search and selection. The status change may also be a combination of channel changes identified as functions such as rapid and repeated channel changes, known as channel surfing, or channel switching between two or more programs over a period of time, often known as channel hopping. The identified change at step 520 may be automatically provided for further processing in process 500 with no further user interaction. The identification at step 520 may alternatively include a prompting message provided to the user. The prompting message may include, for instance, the opportunity to provide or to decline to provide the status change information to other users in the group. Information regarding on screen display messages related to status changes will be described in further detail below.

At step 530, based on the viewing status change of the one user at step 520, a notification message is sent to the remaining users of the identified group. The status change information may be transmitted directly to other users in the group or alternatively may be provided through a webservice on a server and then provided to the remaining users in the group, as described above.

At step 540 a change is determined and identified with respect to the viewing status of a second one of the users in the identified group from step 510. The change at step 540 is detected by the second user's client device (e.g., STB or computer device). As in step 520, the status change may be a channel change or a program guide search and selection. The status change may also be a combination of channel changes identified as functions such as rapid and repeated channel changes, known as channel surfing, or channel switching between two or more programs over a period of time, often known as channel hopping. This second status change, which occurs following the notification message sent at step 530 may be automatically identified as occurring as a result of that notification message and provided for further processing in process 500 without any additional user interaction. Alternatively, the identification at step 540 may also include one or more prompting messages provided to the user. The prompting message may ask the user if the channel change was made based on the recently received and displayed notification (i.e., the notification message at step 530). The prompting message may also include, for instance, the opportunity to provide or to decline to provide the status change information to other users in the group. Information regarding on screen display messages related to status changes will be described in further detail below.

At step 550, an updated notification message is sent including the information about the viewing status change of the first user at step 520 as well as the viewing status change of the second user at step 540. This updated notification message forms the start of, or a continuation of, a viral tuning message sent to the users in the group. The status change information may be transmitted directly to other users in the group or alternatively may be provided through a webservice on a server and then provided to the remaining users in the group, as described above.

It is important to note that operations for providing messages through a web service using a server such as server 116, such as at steps 520 and 550, may offer an additional benefit of allowing users to temporarily opt out of the group by disabling access or functionality with the web service. In some embodiments, the server 116 receives the messages from users, at steps 520 and 540. Server 116 then provides those messages to the other users in the group, at steps 530 and 540, based on the group of users identified at step 510.

Further, it is important to note that the status change information is intended to be made available to other users in the identified and formed group. In this sense, the status change information may remain private and is not public. However, in some embodiments, the second user may also be a member of a second identified and formed user group. This second group may not include the first user. In these embodiments a message indicating the status change of the second user, at step 550, may be sent to the users or members of the second identified user group. This second message would only include information about the status change of the second user and would not include information about the status change of the first user.

The transmission and reception of notification messages or events between users may further be enhanced by establishing a messaging format for the service. In this manner, information may be generated, transferred, and decoded using common communications properties. In one embodiment, the message format includes a time stamp field identifying the time the message was created. The message format then includes a field identifying the current user who has created the message as well as a list of previous users who have previously created the same message. This field, including the list of current and previous users, is used to identify the viral tuning list for the message. The message format may also include a field for identifying a channel as a subject of the message. The channel may be identified as a number or as a logo or call sign. The message format may also include, instead of or in addition to the channel field, a field for identifying the program. The program may be identified as a program name. The message format may also include a status field. This status field may include short status identifiers such as, but not limited to, currently watching, just finished watching, channel surfing, and channel hopping.

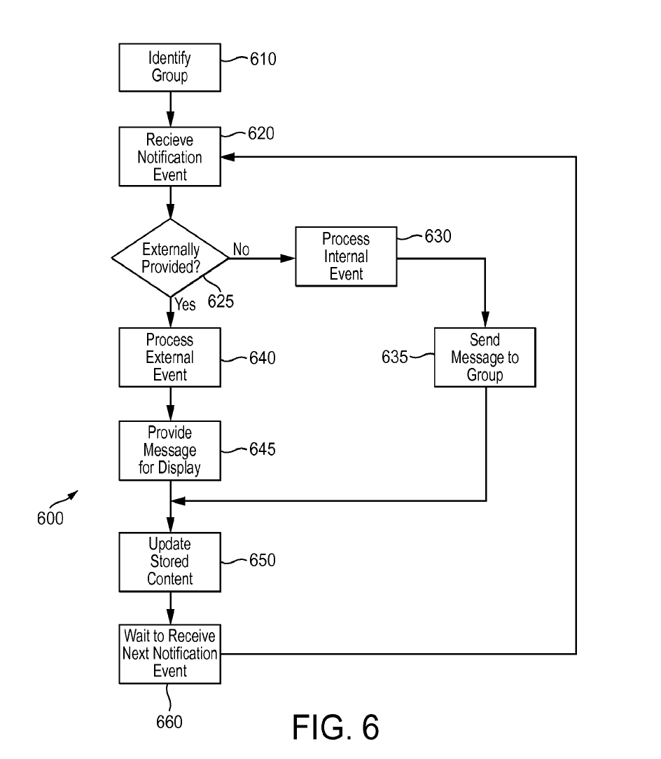

Turning now to FIG. 6, a flow chart of an exemplary embodiment of a process for receiving and processing messages or notification events related to the viewing status or habits of users in an identified group according to aspects of the present disclosure is shown. Process 600 describes the processing steps for events identified for a user as a result of actions by that user, identified as internal notification events or messages. Process 600 also describes the processing steps for messages from other users in the group, identified as external notification events or messages. Process 600 will primarily be described with respect to the device 200 described in FIG. 2. However, one or more of the steps in process 600 may be equally applicable to client devices 108a-108n described in FIG. 1. Furthermore, it is understood that the steps in process 600 rely on communications delivered from a broadcast network source such as delivery network 106 as well as from a secondary network, such as delivery network 112, both described in FIG. 1. Further, it is important to note that some of the steps described in process 600 may be implemented more than once, or may be implemented recursively. Such modifications may be made without any effect to the overall aspects of process 600.

At step 610, a group is identified or selected from a plurality of user groups using the user interface 216. The user groups may be identified and formed as described above in process 500. As a result, the user may select the group or groups to participate with during a current television content viewing session. Device 200 may prompt the user for identification or selection at step 610 during initial device turn on or reset or may provide a menu selection option as part of user interface 216. Alternatively, the user, through user interface 216, may also choose to join more than one group simultaneously. Further, at step 610, if the user is a already a member of one or more user groups, the user may be prompted to opt out of one or more of the groups or be given the opportunity to opt back in to the groups. It is important to note that opting out and opting in is different from joining a group, as described in process 500. The opting out and opting in described here may be viewed as a temporary change that may only be used for a period of time, such as the current television program viewing session by the user. Information regarding the groups that a user is a part of, or has joined, may be stored in a memory, such as control memory 220.

At step 620, after selecting and/or opting into one or more groups at step 610, a notification event is received. The notification event may be received externally at the input signal receiver 202 directly from another user in a selected group or may be received indirectly from another user in a selected group through a webservice. The notification event may also be received internally as a viewing status change, a program ending and another program beginning, or a prompting message response provided through user interface 216. At step 625, a determination is made in controller 214 as to whether the notification event has been externally provided.

If, at step 625, it is determined that notification event was not externally provided then, at step 630, the notification event is processed as an internal notification event. Processing at step 630 may include determining the desire by the user to provide information about the user's current viewing status to other users in the group. Processing at step 630 may also include generating a notification message to be transmitted to other users in the group based on the notification event as well as other notification events as necessary. The internal notification event processing at step 630 will be described in further detail below. At step 635, based on the processing at step 630, the notification message including the user's current viewing status is sent or transmitted to the other users in the group.

If, at step 625, it is determined that the notification event was externally provided then, at step 640, the notification event is processed as an external notification event. Processing at step 630 may include decoding the received notification message in the controller 214 in order to generate a visual display message that is included in, and provided along with, any video program content. The visual display message is based on the notification message information as well as other notification events (internal or external) received previously, as necessary. The external notification event processing at step 640 will be described in further detail below.

At step 645, message generated at step 640 is provided for display on a display device, such as display devices 114a-114n. The message is integrated or otherwise included as part of the video signal provided through display interface 218. Step 645 may also include determining the desire by the user to act on the information received based on the displayed message, such as changing to the channel or viewing the program. This determination may include prompting for a channel change or prompting to ignore further messages about this program or from this user. Further details related to these and other display messages will be described below.

At step 650, after either sending a message following internal event processing, at step 635, or providing a message for display external event processing, at step 645, any status changes or notification event changes are updated and stored. Status changes may include changes to user status (e.g., opt in/out) or changes to response status (e.g., ignore user, channel, program notifications). Further, information regarding the current notification event is stored, providing a database or log of past notification events. The information may also include whether the event was internal or external. This information, including all changes and updates may be stored in a memory, such as control memory 220.

At step 660, process 600 waits for the next notification event and returns to step 620 upon receipt of the new notification event.

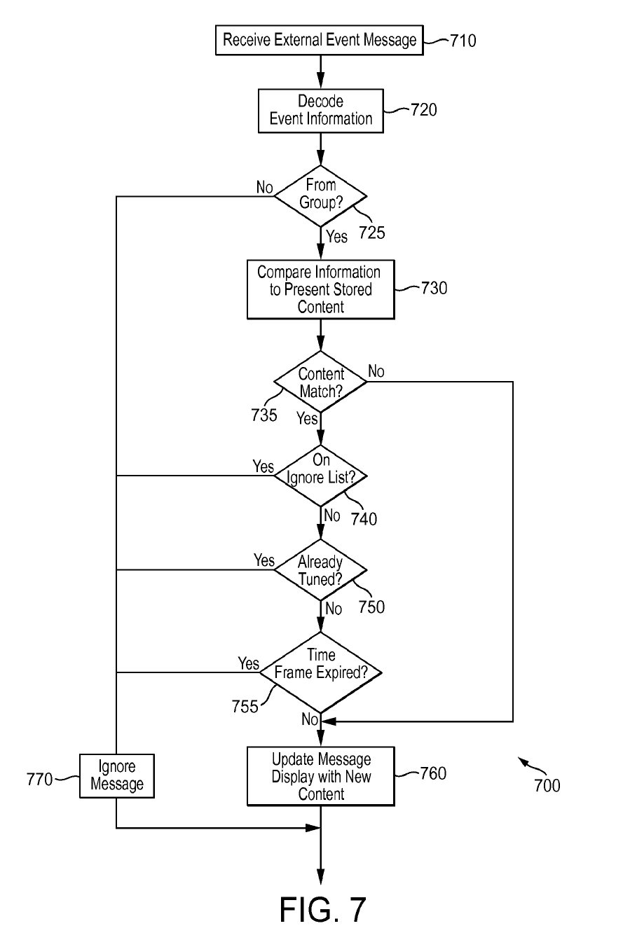

Turning now to FIG. 7, a flow chart of an exemplary embodiment of a process 700 for processing an external notification event message according to aspects of the present disclosure is shown. The steps in process 700 describe a process similar to the processing described at steps 640 and 645 of process 600 described in FIG. 6. In some embodiments, one or more of the process steps in process 700 may be used in place of step 640 and/or step 645 in process 600. Process 700 will primarily be described with respect to the device 200 described in FIG. 2. However, one or more of the steps in process 700 may be equally applicable to client devices 108a-108n described in FIG. 1. Furthermore, it is understood that the steps in process 700 rely on communications delivered from a broadcast network source, such as delivery network 106, as well as from a secondary network, such as delivery network 112, both described in FIG. 1. Further, it is important to note that some of the steps described in process 700 may be implemented more than once, or may be implemented recursively. Such modifications may be made without any effect to the overall aspects of process 700.

At step 710, an event or, message that has been identified as an external event or message by device 200 is received. The external event or message may be identified by an element in device 200 other than controller 214, such as input stream processor 204. Alternatively the external event message may be identified in controller 214 after being received in input stream processor 204 and passed to controller 204 as packets or portions of data not identified as either audio or video data. Next, at step 720, the external event or message is decoded to determine the event or message information. The decoding at step 720 may typically be performed in controller 214 and may include decryption, decompression, and stream or packet parsing techniques as are well known to those skilled in the art. The decoded event information may include, but is not limited to, group identification or source of message, timestamps, information description, and the electronic message itself. The various portions of decoded information may be compared to information stored in device 200 in order to determine whether the received external message should be ignored or displayed, and/or stored.

Next, at step 725, a determination is made as to whether the received external message is from another user who is a member of a currently identified, active, or selected group of users. The determination uses the group or user identifier information in the decoded message and compares it to information previously generated at stored in device 200, such as is described at step 610 in FIG. 6. If at step 725, the message is from the group or a user in the group, then at step 730 a further series of comparisons between information in the received message and information stored in device 200 about the current user preferences and previous message is performed.

At step 735, a determination is made as to whether, the content of the message matches content previously received. In other words, the comparison may at the subject matter of the content, such as the channel or program that is being watched, or the status of the user. The content match determination at step 735 may also look at the user or group that sent the message.

If, at step 735, a content match is found then, at step 740, a determination is made, based on the matched content, as to whether this content is on a list of ignored content. As described earlier, the user, through a user interface on device 200, may place certain content that is received externally on an ignore list, the list being stored in a memory in device 200. By doing so, the user may eliminate undesired or unwanted visual updates or interruptions to current program viewing. The user may set or establish a condition to ignore any or all messages.

If, at step 740, a determination is made that the content is not on the ignore list then, at step 750, a determination is made as to whether the program or channel that is the subject of the message is already or currently tuned or being viewed. This condition may exist if the user of device 200 has already tuned the channel or is viewing the program based either on his/her preference or based on a previously received external message.

If, at step 750, the determination is made that the channel is not currently tuned or the program is not currently being viewed then, at step 755, a determination is made as to whether a time frame for the message has been passed or has expired. This determination at step 750 may be based on another portion of information in the received and decoded message. For example, the incoming message may include both a delivery time stamp as well as a valid time period time stamp. The incoming message may also include information that the message is part of a viral tuning string of messages and indicate a time when the first message in the string was generated. Further, a user, through device 200, may establish a time period that messages are only to be received for a time period of 5 minutes before or 5 minutes after the start of a program or at the top and bottom of each hour. The user may also select a time period during which all messages received are to be ignored. Still further, device 200 may determine that the program that is the subject of the message has ended.

If, at step 755, a determination is made that the time period for the message is valid and/or has not expired then, at step 760, the message content is updated and provided for display. Additionally, if the received content, during the determination, at step 735, does not match previous content, then the received message is similarly updated and provided for display. The processing, at step 760, may also include any display formatting necessary for the message. The processing, at step 760, may further include any signal conversion in order to make the received message information compatible with the display format.

If the received message is not from an identified group or from a user in that group, the content in the message is on the ignore list, the channel is already tuned, or program already being viewed, or the time frame has expired or is invalid, then, at step 770, the received and decoded message is identified as an ignored message. Following either step 760 or step 770 further processing may be performed, such as the processing at step 650 in FIG. 6.

The steps in process 700 may be further enhanced by the use of a recognized or established event or message format, as described above. The use of an established event or message format allows the controller 214 to easily parse the received event or message and also to easily generate the display message in a unified display format easily read and understood by the user.

It is important to note that the steps in process 700 describe only a preferred embodiment. In other embodiments, certain steps in process 700 may be rearranged or may be eliminated. For example, in one embodiment if a content match is not found, at step 735, the process may proceed to determine, at step 750, if the channel or program that is the subject of the message is already tuned or being viewed. Further, although the comparisons in steps 730 through 755 are shown as being performed serially, it is possible that one or more of the steps may be performed in parallel. For instance, the processing at step 735, step 750, and step 755 may be performed at the same time, with the results from any of these steps leading to the subsequent steps directly, as described above.

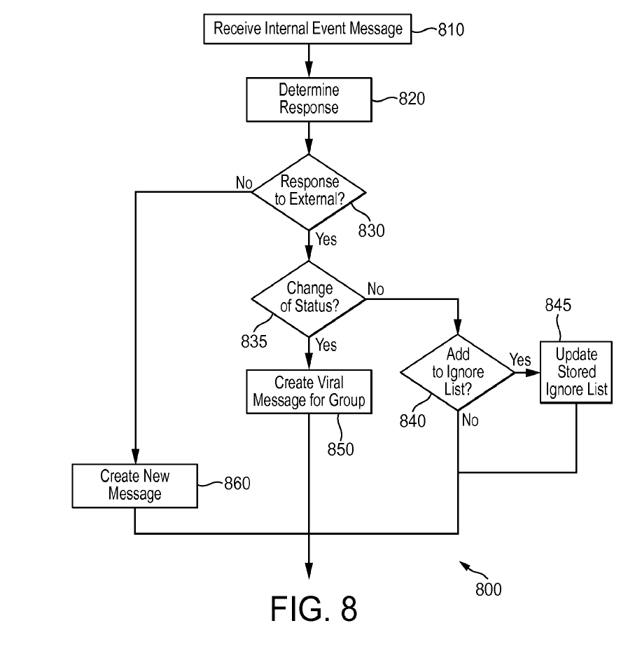

Turning now to FIG. 8, a flow chart of an exemplary embodiment of a process 800 for processing an internal notification event or message according to aspects of the present disclosure is shown. The steps in process 800 describe a process similar to the processing described at steps 630 and 635 of process 600 described in FIG. 6. In some embodiments, one or more of the process steps in process 800 may be used in place of step 630 and/or step 635 in process 600. Process 800 will primarily be described with respect to the device 200 described in FIG. 2. However, one or more of the steps in process 800 may be equally applicable to client devices 108a-108n described in FIG. 1. Furthermore, it is understood that the steps in process 800 rely on communications delivered from a broadcast network source such as delivery network 106 as well as delivered to and from a secondary network, such as delivery network 112, both described in FIG. 1. Further, it is important to note that some of the steps described in process 800 may be implemented more than once, or may be implemented recursively. Such modifications may be made without any effect to the overall aspects of process 800.

At step 810, an event or message that has been identified as an internal event message by device 200 is received. Examples of internal events or messages may include, but are not limited to, a channel change, a currently viewed program ending and another program beginning, a response to a message prompt provided as part of the display signal from device 200, or a user selection in a user interface menu provided to a display device. It is important to note that unlike an external event or message previously described, an internal event or message is derived or initiated by some action taken by the user. This action is then identified or detected by the device 200. The internal event or message may be identified in controller 214, for instance, as part of its operation for execution of a channel change in device 200. The internal event or message may alternatively be identified by an element in device 200 other than controller 214, such as a user input through user interface 216.

At step 820 a series of comparisons or determinations are initiated in order to determine the final output of process 800. Further, these comparisons or determinations may rely on additional information that resides, or is stored, in device 200. This additional information may include current user preferences and previous messages.

At step 830, a determination is made as to whether the currently received internal message is a response to a recently received and displayed external message. As described earlier, a user may choose to change a channel or view a program in response to receiving a message that one or more other users in an identified group are watching the channel or program. The response provided by the user, resulting in the creation and/or identification of an internal event, may be identified as a channel change to the same channel as the channel included in the content of the received external event message. Alternatively, the internal event may be created as part of a response to a prompt that was included in the original message display as part of the received external event message. A response to a prompt may include accepting the action or tuning to the channel or program, adding the message or user to an ignore list, or exiting as an acknowledgment without taking any further action.

If the response, at step 830, is determined to be a response to a previous external event message, then, at step 835, a determination is made as to whether the received internal event requires a change in status. This change in status may indicate a desire to notify other users in the group. This change in status may either establish or further indicate a string of messages identifying a viral tuning is occurring.

If the response at step 835 does not require a change in status then, at step 840, a further determination is made as to whether the internal event includes a request to add information to an ignore list. Information may be added to the ignore list based on content identified from an external event message previously received (e.g., the most recently received event message). Information may also be added to the ignore list based solely on inputs through a user interface from a user independent of other messages or events. For example, a user may choose to establish certain information on the ignore list at the time of initial start up or logging in to the group.

As described earlier, the user, through a user interface on device 200, may place certain content that is received externally on an ignore list, the list being stored in the memory of device 200. The use of the ignore list by a user may eliminate undesired or unwanted visual updates or interruptions to the current program viewing. In a limit condition, a user may set a condition to ignore all messages. Changes or additions to the ignore list may include changes to user status (e.g., opt in/out) or changes to response status (e.g., ignore user, ignore message type, ignore channel, or ignore program notifications).

If, at step 840, the information is to be added to the ignore list then, at step 845, the ignore list is updated with the identified information (e.g., user, program, channel) and stored in a memory, such as controller 220 in device 200. If instead, at step 840, no information is to be added to the ignore list, then no additional action from process 800 is necessary. This condition may occur if the user has simply exited the display message without requiring any action.

If, at step 835, the determination is made to change status then, at step 850, a message is created to indicate that the user's status has changed. The message may further indicate that the status represents a viral tuning or viewing, such as by including information from a previously received message. Information related to messages for display will be provided in further detail below.

If, at step 830, the determination is made that the internal event or message is not as a result of a previous external event or message, then a new message is generated, at step 860, indicating the current status for the viewing habits of the user. For example, the new message may indicate that the user has performed a channel change. Alternatively, the message may indicate that the user has not changed channels for a predetermined time period or that the user has been changing channels randomly or methodically (i.e., channel surfing) or in a set channel changing pattern (i.e., channel hopping).

It is important to note that the process for determining a status change, such as a channel change, channel surfing, or channel hopping may include a user's client device (e.g., host device 200) monitoring the user's actions for a predetermined period of time. The status change information is determined based on the results of monitoring over the predetermined time period and then the message is generated, at step 860. For example, in one embodiment, a user's actions are monitored in 60 second increments. If, in a 60 second increment, the user changes channels more than three times and none of the channels are the same, the client device identifies the status change as channel surfing. If in a 60 second increment, the user changes channels more than three times and at least two of the channels are the same, the client device identifies the status change as channel hopping between the at least two channels.

The steps in process 800 may be further enhanced by the use of a recognized or established event or message format, as described above. The use of an established event or message format allows the controller 214 to easily identify and generate the portion of the event or message to be provided to the client devices (e.g., settop boxes) for the other users in the group.

Following completion of steps 840, 845, 850, and 860, process 800 is completed and additional processing may be continued in another process, such as at step 650 in FIG. 6 described above.

It is important to note that the steps in process 800 describe only a preferred embodiment. In other embodiments, certain steps in process 800 may be rearranged or may be eliminated. For example, in one embodiment, if at step 840 the internal event does not require, an addition to the ignore list, the process may be proceed from this point to step 860 to create a new message based on the information that was included in the internal event, even if the information is just an acknowledgment from the user. Further, although the comparisons in steps 830 through 840 are shown as being performed serially, it is possible that one or more of the steps may be performed in parallel. For instance, the processing at step 835 and 840 may be performed at the same time, with the results from these steps leading to the subsequent steps in process 800 directly, as described above.

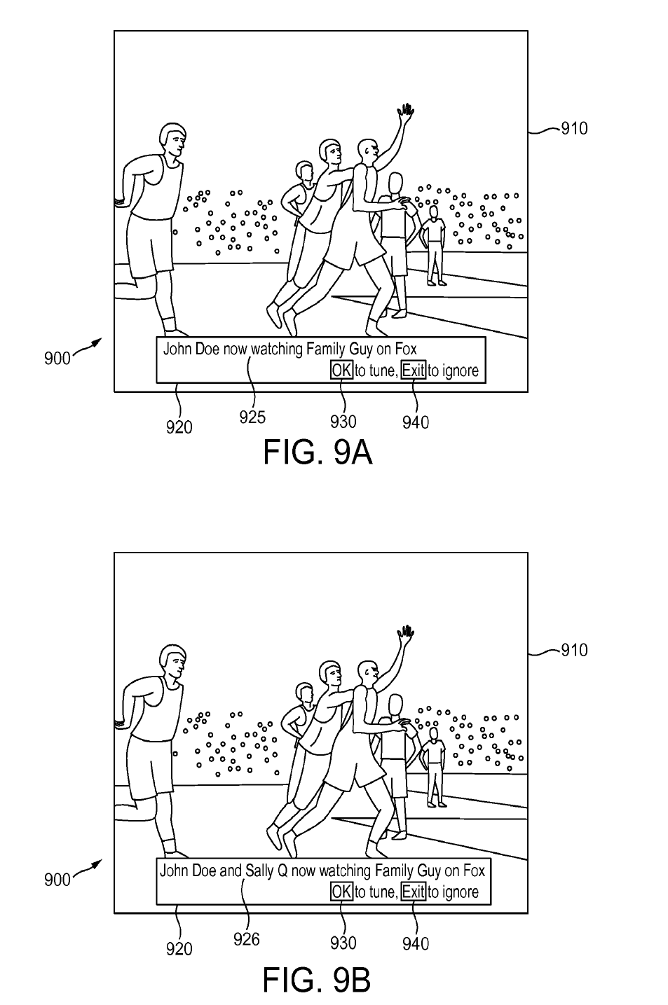

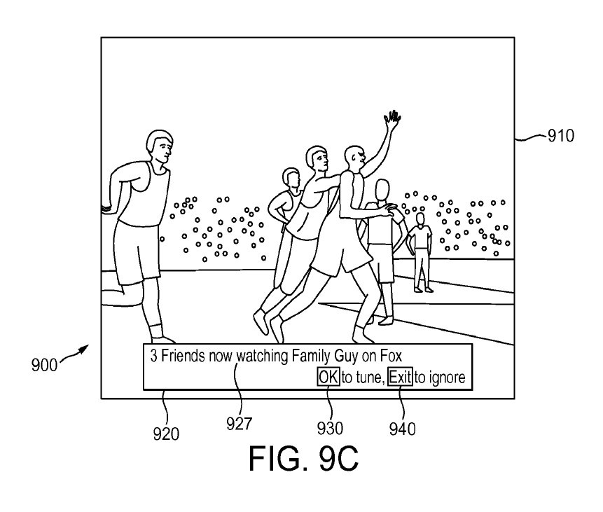

Turning to FIGS. 9A-9C, a diagram illustrating an exemplary image display 900 of a user interface for viewing notification messages according to aspects of the present disclosure is shown. Image display 900 is shown on a display device, such as one of the display devices 112a-112n described in FIG. 1, and displays content received and processed in a client or host device (e.g., one of client devices 108a-108n described in FIG. 1 or host device 200 described in FIG. 2).

Image display 900 includes an image of a currently viewed video program 910. During viewing of video program 910, notification messages related to the viewing status of a friend in the network are processed in the client or host device and displayed in an overlay window 920 at the bottom of the display screen. It is important to note that the location and/or size of the overlay window 920 may be different than as shown in image display 900. Further, the format and/or aspect ratio of the video program 910 may be modified in order to view the entire video program 910 with the overlay window 920 displayed in a portion of the display screen outside of the area of the video program 910.

Included in overlay window 920 is a region for display of a text message. The text message may conform to a number of protocols and represents the current notification message from the viewing network or an identified group. The message is displayed after having been received and processed in host device, such as host device 200 described in FIG. 2 using a process, such as process 600 described in FIG. 6 or process 700 described in FIG. 7. FIG. 9A includes a first instance of a notification message 925. Message 925 indicates a first user, John Doe, is now watching a particular program. As described above, FIG. 9B, includes the second instance of a notification message 926 that is related to, or an update message to, message 925. In message 926, a second user, Sally Q, along with John Doe, is now watching the particular program. In FIG. 9C, a further notification message 927, as an update message to messages 925 and 926, indicates that three (or more) friends or users in the user group are now watching the particular program. The viral tuning identification and notification process would continue as long as users in the group continue to update their status by tuning to and watching the particular program.

In addition to the message space in overlay window 920, selection buttons are also included. Selection buttons include an “OK to tune” button 930 and an “EXIT to ignore” button 940. These buttons may be identifications for specific selection buttons available on a remote control device. These buttons may also represent cursor locations on the display that may be selectable using a cursor control and separate selection button or other gesture mechanism.

If the OK to tune button 930 is chosen in overlay window 920, the client or host device tunes to the channel that includes the selected program stream. At this point as previously described, further messages related to the viewing status of other users in the group associated with the particular program may no longer be displayed. If the EXIT to ignore button 940 is chosen, any remaining messages related to the particular program (e.g., messages 926, 927 after receiving message 925) will not be displayed. A similar condition may be established as a prompt in window overlay 920 for ignoring messages related to particulars users instead of particular programs or channels.

It is important to note that the overlay window 920 may remain on the display screen 910 indefinitely once the first status display update message is received. The message within display window 920 is updated when a new notification is received (e.g., message 925 remains displayed until message 926 is received.). Alternatively, the overlay window 920 may remain on the screen for a predetermined period of time before closing (e.g., a ten second time period). Still further, the display window 920 may be removed from the display screen 910 by an additional user interface step, such as pushing any other button on a remote control device or pressing an additional identified button in overlay window 920 (not shown).

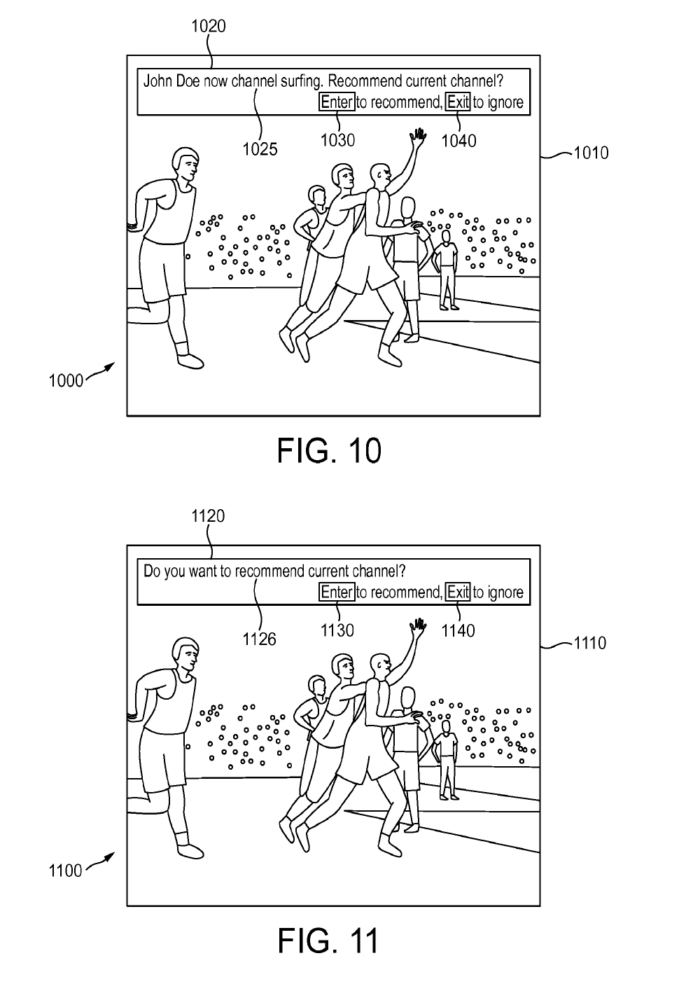

Turning to FIG. 10, a diagram illustrating another exemplary image display 1000 of a user interface for viewing notification messages according to aspects of the present disclosure is shown. Image display 1000 represents an embodiment that includes displaying a received external message and further potentially generating a response message or event that is provided to other users in the group. Image display 1000 is shown as a visual display on a display device, such as one of the display devices 114a-114n described in FIG. 1, and displays content received and processed in a client or host device (e.g., one of client devices 108a-108n described in FIG. 1 or host device 200 described in FIG. 2).

Image display 1000 includes an image of a currently viewed video program 1010. During viewing of video program 1010, notification messages related to the viewing status of a friend in the network are processed in the client or host device and displayed in an overlay window 1020 at the top of the display screen. It is important to note that the location and/or size of the overlay window 1020 may be different than as shown in image display 1000. Further, the format and/or aspect ratio of the video program 1010 may be modified in order to view the entire video program 1010 with the overlay window 1020 displayed in a portion of the display screen outside of the area of the video program image 1010.

Included in overlay window 1020 is a region for display of a text message. The text message may conform to a number of protocols and represents the current notification message from the viewing network. Display window 1020 includes a notification message 1025 indicating that a particular user has been channel surfing. As a result, message 1025 further asks if the user would like to recommend the currently viewed program image 1010 as a status update event notification to other users in the group.

In addition to the message space in overlay window 1020, selection buttons are also included. These buttons include an “ENTER to recommend” button 1030 and an “EXIT to ignore” button 1040. These buttons may be identifications for specific selection buttons available on a remote control device. These buttons may also represent cursor locations on the display that may be selectable using a cursor control and separate selection button or other gesture mechanism.

If the ENTER to recommend button 1030 is chosen, the client or host device generates a notification message. The message is then provided through a network, such as Internet 112 to the other users in the group, as previously described. If the EXIT to ignore button 1040 is chosen, any remaining messages related to the particular user will not be displayed.

It is important to note that the overlay window 1020 may remain on the display screen 1010 indefinitely once the first status display update message is received. The message within display window 1020 is updated when a new notification (external or possibly internal) is received for display (e.g., message 1025 remains displayed until another message is displayed). Alternatively, the overlay window 1020 may remain on the screen for a predetermined period of time before closing (e.g., a ten second time period). Still further, the display window 1020 may be removed from the display screen 1010 by an additional user interface step, such as pushing any other button on a remote control device or pressing an additional identified button in overlay window 1020 (not shown).

Turning to FIG. 11, a diagram illustrating another exemplary image display 1100 of a user interface for viewing notification messages according to aspects of the present disclosure is shown. Image display 1100 represents an embodiment that includes displaying a message on the display as a result of identifying a received internal event, such as a channel change by the user. The display includes a prompt for determining if a message is to be generated and provided to other users in the group. Image display 1100 is shown as a visual display on a display device, such as one of the display devices 114a-114n described in FIG. 1, and displays content received and processed in a client or host device (e.g., one of client devices 108a-108n described in FIG. 1 or host device 200 described in FIG. 2).

Image display 1100 includes an image of a currently viewed video program 1110. During viewing of video program 1110, notification messages related to the viewing status of a friend in the network are processed in the client or host device and displayed in an overlay window 1120 at the top of the display screen. It is important to note that the location and/or size of the overlay window 1120 may be different than as shown in image display 1100. Further, the format and/or aspect ratio of the video program 1110 may be modified in order to view the entire video program 1110 with the overlay window 1120 displayed in a portion of the display screen outside of the area of the video program image 1110.

Included in overlay window 1120 is a region for display of a text message. The text message may conform to a number of protocols and represents the current notification message from the viewing network. Display window 1120 includes a notification message 1126 asking if the user would like to recommend the currently viewed program image 1110 as a status update event notification to other users in the group.

In addition to the message space in overlay window 1120, selection buttons are also included. These buttons include an “ENTER to recommend” button 1130 and an “EXIT to ignore” button 1140. These buttons may be identifications for specific selection buttons available on a remote control device. These buttons may also represent cursor locations on the display that may be selectable using a cursor control and separate selection button or other gesture mechanism.

If the ENTER to recommend button 1130 is chosen, the client or host device generates a notification message. The message is then provided through a network, such as Internet 112 to the other users in the group, as previously described. If the EXIT to ignore button 1140 is chosen, any remaining messages related to the particular user will not be displayed.

It is important to note that the overlay window 1120 may remain on the display screen 1110 indefinitely once the first status display update message is received. The message within display window 1120 is updated when a new notification (external or possibly internal) is received for display (e.g., message 1126 remains displayed until another message is displayed). Alternatively, the overlay window 1126 may remain on the screen for a predetermined period of time before closing (e.g., a ten second time period. Still further, the display window 1120 may be removed from the display screen 1110 by an additional user interface step, such as pushing any other button on a remote control device or pressing an additional identified button in overlay window 1120 (not shown).

As described earlier in FIG. 2, the on screen displays shown in FIGS. 9A-9C, 10, and 11 may alternatively be interfaced to a second screen device, such as a handheld display or tablet device. The display content may be changed to fit the smaller screen as well as adapted for operation using touch screen technology. However, this adaptation for use of a second screen, and others similar, are known to one skilled in the art and therefore within the scope of the present disclosure.

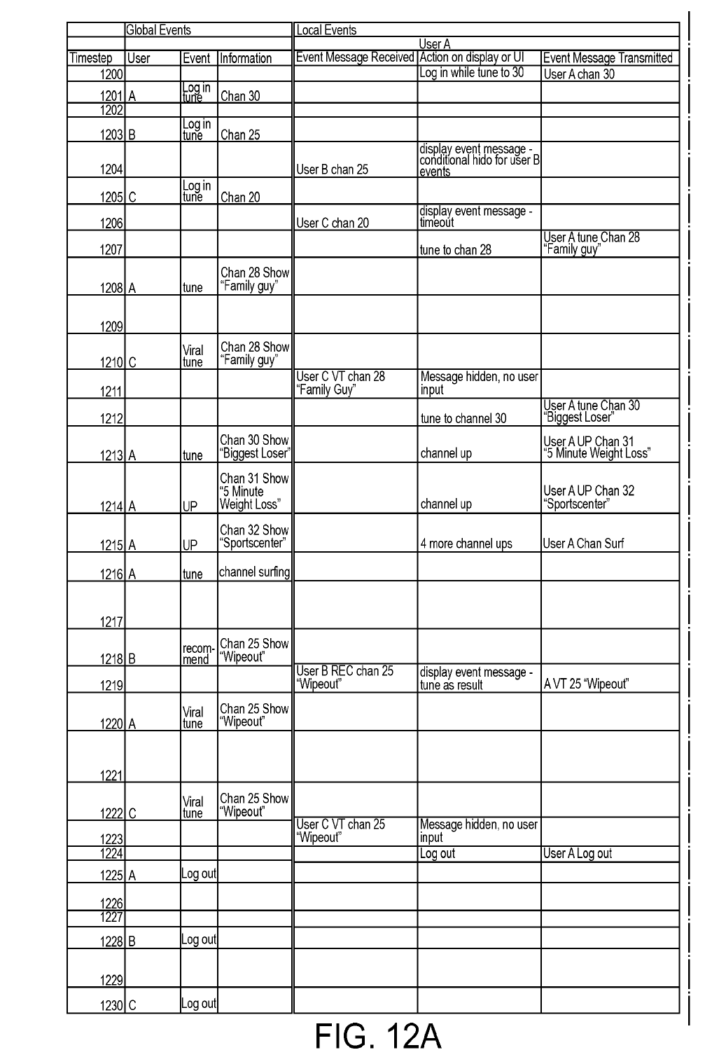

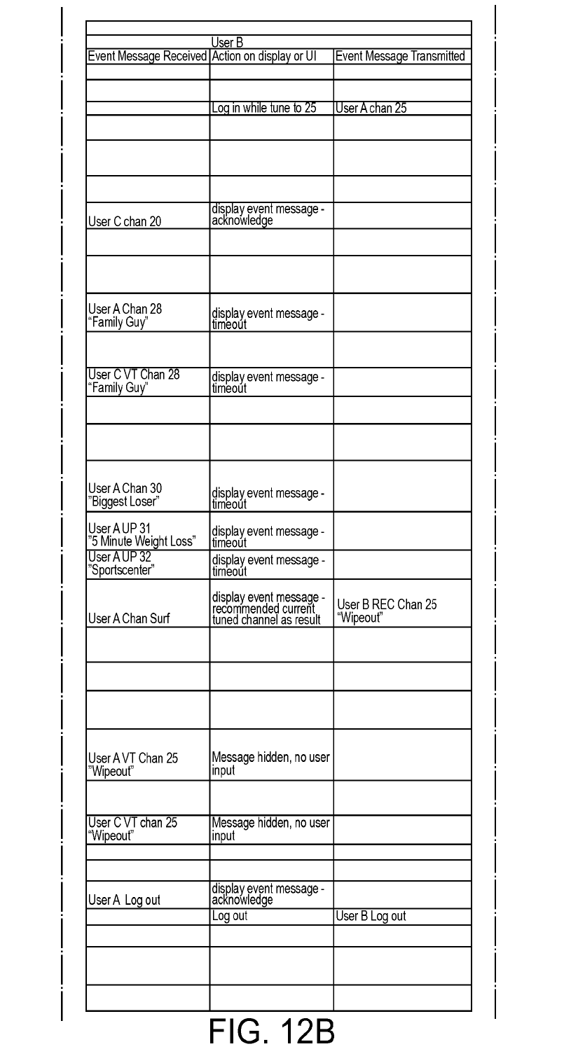

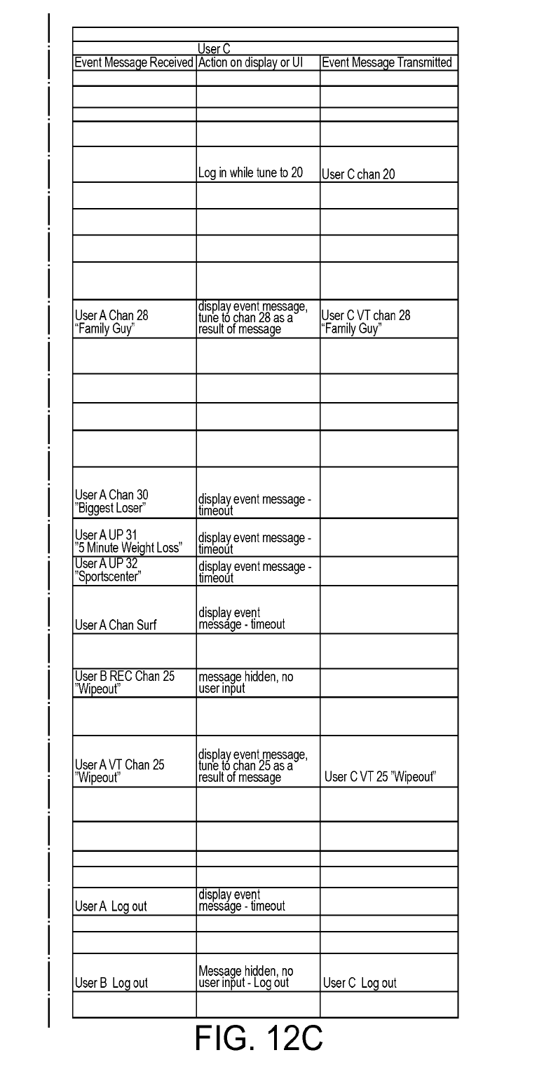

Turning now to FIG. 12, a diagram of an exemplary event timeline for a set of users networked together in a user group according to aspects of the present disclosure is shown. The event timeline indicates a series of events related to the transmission and reception of event messages using processes described above in FIGS. 5-8.

FIG. 12 shows a timeline using timestep increments running vertically and a log of events or occurrences at each timestep increment running horizontally. The horizontal portion includes a region labeled Global Events. In one embodiment, this region may represent the events and information processing that occurs in a server connecting users in a user group over a network, such as server 116 described in FIG. 1. In other embodiments, such as embodiments that connect or network users in a group without the use of a server interface, the Global Event portion may be viewed a master listing of events for all users. Within the Global Event portion, the timeline is shown, along with a column identifying the user that initiated the event message, a column for the event message type, and a column for any other information related to the event message (e.g., the channel or the program). The event message type and the related information are similar to the information described above in Table 1.

It is important to note that the event timeline in FIG. 12 shows a time increment that is, for illustrative purposes, in single unit increments. The timeline shows a time delay of one increment for an event message transmission and of one increment for an event message reception. In other embodiments, the actual event timeline may be measured in any time units that are appropriate, such as seconds or minutes. The event timeline also shows certain events related to transmission and reception of event messages by the same user as occurring in the same time increment. However, it is understood that some time may pass between the reception of an event message, the processing of the received event message, and the generation and transmission of a new event message following the processing. Further, some events may include set time increments that are different than shown. Additionally, other events, such as transmission and reception of event messages, may occur simultaneously or otherwise in a different manner than shown in FIG. 12.

The remaining horizontal portion is labeled Local Events and includes activities associated with three users in the same user group, User A, User B, and User C. For each of the three users, columns identifying the Event Message Received, Action on the display or UI, and the Event Message Transmitted are shown. Columns labeled Event Message Received and Event Message Transmitted identify the incoming or outgoing event messages received or transmitted by a client or host device (e.g., settop box, gateway, display device, television) used by the users in the group. The event messages show the data commands and information sent through the network. The data commands are similar to those commands described above in Table 1. The column labeled Action on the display or UI identifies the interface between the client device and the user. In some instances, a received event message is processed, and the information from the received event message is provided for display to the user, similar to that described above in FIGS. 9A-9C. In other instances, the client device provides a prompt message for display, requesting further input of information from the user. The information input by the user is used to generate and transmit an event message, similar to that described above in FIG. 10 and FIG. 11.

It is important to note that information related to channels tuned may be different than shown in FIG. 12. In the present embodiment, each of the users is using the same video broadcast provider network, such as delivery network 106 described in FIG. 1. However, in some embodiments, some or all users in the user group may be on different video broadcast provider networks. In these embodiments, a tuning event may be identified by a channel name rather than by a channel number.

Referring to the event timeline, at timestep 1200, User A logs in to the user group while tuned to channel 30. User A, as well as any other users, may log in, or opt in, to the group using a display message prompt as part of the user interface. Alternatively, the client device may automatically log in, or opt in, to a user group after a power on or initialization sequence. A message is sent from User A's client device indicating User A has logged in and is currently tuned to channel 30. At timestep 1201, User A's message is received at the server as shown in the Global Event portion. Since User A is the first user logged in to the user group, the message is not sent to any other users.

At timestep 1202, User B logs in to the user group while tuned to channel 25 and a message is sent from User B's client device. At timestep 1203, User B's message is received at the server. Since User A is also active in the user group, user B's message is sent from the server to User A's client device. At timestep 1204, user B's message is received and decoded in User A's client device. User B's message is displayed. As a result of user B's message, User A chooses to conditionally hide all future messages from user B. The condition is identified as display only recommendation messages from user B.

Also at timestep 1204, User C logs in to the user group while tuned to channel 20 and a message is sent from User C's client device. User C sets up some initial display settings in the user interface that include displaying messages only sent from User A. At, timestep 1205, User C's message is received at the server. Since User A and User B are also active in the user group, user C's message is sent from the server to both User A's client device and User B's client device. At timestep 1206, user C's event message is received and decoded in User A's client device. After display of User C's message, User A chooses no response or acknowledgment and the message display times out. Also, at timestep 1206, user C's event message is received and decoded in User B's client device. After display of User C's message, User B chooses to acknowledge the message with no further action.

It is important to that although not shown, in some embodiments User A's initial event message at log in, at step 1201, may be sent to User B after User B logs in, at step 1202. Similarly, User A's initial event message, at step 1201, and User B's initial event message, at step 1202, may be sent to User C after User C logs in, at step 1204. In this manner, each user is aware of the status of any users previously logged in. This process may be limited only to each previously logged in user's current status or may be further extended to include any messages from previously logged in users.

At timestep 1207, User A tunes to a new channel, channel 28, also identified as the program “Family Guy”. A new message, identifying the new tuning by User A, is sent from User A's client device. At timestep 1208, User A's new event message is received at the server and further sent on to both User B's client device and User C's client device. At timestep 1209, user A's new event message is received and decoded in User B's client device. After display of User A's message, User B chooses no response or acknowledgment and the message display times out. Also, at timestep 1209, user A's new event message is received and decoded in User C's client device. After display of User A's message, user C tunes to channel 28 to begin viewing the program “Family Guy”. As a result of tuning to channel 28, a message is generated and sent from User C's client device indicating that User C has viral tuned channel 28.

At timestep 1210, User C's new viral tuning message is received at the server and further sent on to both User A's client device and User B's client device. At timestep 1211, User C's new message is received and decoded in User A's client device. User C's message is not displayed to User A because the original source of the viral, tuning is User A and also user A is currently tuned to channel 28. In one embodiment, User A's client device compares the incoming event message to messages previously generated and sent and, if necessary, to the current viewing status to determine if the current message should be displayed or not. Also, at timestep 1211, User C's new message is received and decoded in User B's client device. After display of User C's message, User B chooses no response or acknowledgment and the message display times out. It is important to note that, as described above, the display information from User B's client device may include information that both User A and User C have tuned to channel 28 based on the viral tuning event identification provided in User C's event message and the processing of this event message with previous event messages (i.e., User A's event message) in User B's client device.

Timesteps 1212 to 1214 show a series of tuning messages generated and sent by User A's client device as a result of User A tuning a series of different channels. Each of these messages is received by User B's client device and User C's client device at timesteps 1213 to 1215. Also, at timestep 1215, after four additional channel tuning events by User A, User A's client device generates and send an event message identifying User A as channel surfing. As described previously, certain actions (e.g., rapid channel changing, channel surfing, or channel hopping) may be identified by the client device. The client device may automatically generate and send an event message based on the identified action. Alternatively, the client device may generate a response prompt through the user interface to determine whether information related to the user's current status or action should be sent to the other users in the group.

At timestep 1216, User A's channel surfing message is received at the server and further sent on to both User B's client device and User C's client device. At timestep 1217, the message is received, decoded, and displayed to User C. User C chooses no acknowledgment, allowing the display message to timeout. The message is also received, decoded, and displayed to User B, with the display message including a request for a recommendation. User B inputs a recommendation for the currently tuned channel 25 and program “Wipeout” through the user interface. A message is generated and sent from User B's client device that indicates User B is recommending channel 25 and program “Wipeout”.

At timestep 1218, User B's recommendation message is received at the server and further sent on to both User A's client device and User C's client device. At timestep 1219, User B's recommendation message is received and decoded in User A's client device. User B's message is displayed to User A because the message is a recommendation message and satisfies the previously set threshold for displayed messages from User B, as established above at timestep 1204. After display of User B's message, User A tunes to channel 25 to begin viewing the program “Wipeout”. As a result, a message is generated and sent from User A's client device indicating that User A has viral tuned channel 25. Also, at timestep 1219, User B's recommendation message is received and decoded in User C's client device but is not displayed based on the previous message event display settings established by User C at timestep 1204.

At timestep 1220, User A's new viral tuning message is received at the server and further sent on to both User B's client device and User C's client device. At timestep 1221, User A's new viral tuning message is received and decoded in User B's client device. User A's message is not displayed to User B because the original source of the viral tuning event is identified as User B and User B is currently tuned to channel 25. Also, at timestep 1221, user A's new viral tuning message is received and decoded in User C's client device. After display of User A's message, user C tunes to channel 25 to begin viewing the program “Wipeout”. As a result, a message is generated and sent from User C's client device indicating that User C has viral tuned channel 25.

At timestep 1222, User C's new viral tuning message is received at the server and further sent on to both User A's client device and User B's client device. At timestep 1223, User C's new message is received and decoded in User A's client device. User C's message is not displayed to User A because one of the sources of the viral tuning event is User A and User A is also currently tuned to channel 25. Also, at timestep 1223, User C's new message is received and decoded in User B's client device. User C's message is not displayed to User B because User B originally recommended channel 25, User B is one of the sources of the viral tuning event, and User B is currently tuned to channel 25.

Timesteps 1224 to 1230 show a set of events related to each of the users logging out, or opting out, of the user group. At timestep 1224, User A logs out, or opt out, of the user group. User A, as well as any other users, may log out, or opt out, of the group using a display message prompt as part of the user interface. Alternatively, the client device may automatically log out, or opt out, of a user group after a power off sequence. A message is generated and sent from User A's client device indicating User A has logged out.

At timestep 1225, User A's log out message is received at the server. Since User B and User C are still active in the user group, user A's message is sent from the server to both User B's client device and User C's client device. At timestep 1226, user A's message is received and decoded in User B's client device. After display of User A's message, User B chooses to acknowledges the message with no further action. Also, at timestep 1226, user A's message is received and decoded in User C's client device. After display of User A's message, User C chooses not to acknowledge the message and the message display times out.

At timestep 1227, User B logs out of the user group. A message is generated and sent from User B's client device indicating User B has logged out. At timestep 1228, User B's log out message is received at the server. Since User C is still active in the user group, user B's message is sent from the server to User C's client device. At timestep 1229, user B's message is received and decoded in User C's client device. User B's message is not displayed because of User C's previous message display settings established at timestep 1204. Also, at timestep 1229, User C logs out of the user group. A message is generated and sent from User C's client device indicating User C has logged out. At timestep 1230, User B's log out message is received at the server.

The event timeline shown in FIG. 12 shows a series of events for three users. However, similar event timelines may exist for more than three users, with different users logging in and logging out of the user group at various times. Users may also change message display settings dynamically as a result of the event messages received while continually providing viewing status updates and viral tuning to various programs based on status updates from other users in the group.

The present embodiments describe an apparatus and method for networking content consumption status to users in a group. The embodiments describe operations for interfacing a group of users' content consumption (e.g., television or program viewing) habits into a user group, such as a social networking subgroup, and virally updating all of the users in that user group based on the group's continuing habits and status. A first user's consumption habits are monitored and certain viewing characteristics are identified, such as the channel viewed and channel changes. The information associated with the identified characteristics is provided the network. This information may then be accessed by, or is provided to, other participants in the group. A second user identifies the changes made by the first user and acts based upon the changes. The second user's change then triggers further information that is provided through the network to the participants in the social networking group. The viral tuning between users (e.g., a third, fourth, and fifth user) may continue until the users either log off or until the remaining users do not continue to virally tune to the channel. Information is provided as event or message notifications and may be generated automatically based on the user's actions while watching video programming.

Although embodiments which incorporate the teachings of the present disclosure have been shown and described in detail herein, those skilled in the art can readily devise many other varied embodiments that still incorporate these teachings. Having described preferred embodiments of a system and method for enabling a user to display and interact with a social networking structure on a video device connected to a network enabled host device (which are intended to be illustrative and not limiting), it is noted that modifications and variations can be made by persons skilled in the art in light of the above teachings. It is therefore to be understood that changes may be made in the particular embodiments of the disclosure disclosed which are within the scope of the disclosure as outlined by the appended claims.

1. A method comprising:
receiving input data, the input data indicating that a first user in a user group has changed a content consumption characteristic;
determining if the first user's changed content consumption characteristic is based a content consumption characteristic of a second user in the user group; and
generating a message that is provided to at least one other user in the user group, the message including information indicating that the first user's changed content consumption characteristic is based on the content consumption characteristic of the second user in the user group.

2. The method of claim 1, further comprising the step of determining if the input data was generated by a user input from the first user or if the input data was received from a network interface.

3. The method of claim 2, wherein the message is provided to at least one other user in the user group of the network interface based on determining that the input data was generated by a user input from the first user.

4. The method of claim 2, further comprising the step of providing the message for display based on determining that the input data was received from the network interface.

5. The method of claim 3, wherein the step of providing the message further includes the steps of:
determining if the first user has indicated that the received input data is to be ignored;
providing the message for display to the first user if the first user has indicated that the message is not to be ignored.

6. The method of claim 5, wherein the step of providing the message further includes the steps of:
determining if the received input data is associated with previous input data generated by the first user; and
providing the message for display to the first user if the received input data is not associated with previous input data generated by the first user.

7. The method of claim 1, wherein the input data includes an indication of a viewing status change of a media program by the user.

8. The method of claim 7, wherein the viewing status change includes at least one of tuning a media program, viral tuning a media program, viewing a program, recommending a program, channel surfing, and channel hopping.

9. The method of claim 7, wherein the viewing status change is tuning a channel, wherein the second user's content consumption characteristic includes an indication that the second user tuned the same channel, and wherein the message generated indicates that the first user has viral tuned the same channel.

10. The method of claim 7, wherein the viewing status change is tuning a channel, wherein the second user's content consumption characteristic includes recommending the same channel, and wherein the message generated indicates that the first user has viral tuned the same channel.

11. The method of claim 1, wherein the input data is received through a user interface on a device used by the first user.

12. The method of claim 1, wherein the input data is received through at least one of a signal receiver and a user interface on a device used by the first user and connected to a network that includes the at least one other user in the user group.

13. The method of claim 1, wherein the input data received from the first user is received by a device used for receiving the media program by the first user.

14. The method of claim 13, wherein the media program is received over a first network and the input data that was previously received from at least one other user in the user group is received over a second network.

15. An apparatus comprising:
a transceiver circuit that is coupled to a network, the network interfacing a plurality of users in a user group; and
a controller circuit coupled to the transceiver circuit, the controller circuit receiving input data from a first user, the input data indicating that the first user has changed a content consumption characteristic, the controller circuit further determining if the first user's change in content consumption characteristic is based on input data received through the transceiver circuit from a second user, the second user's input data indicating a content consumption characteristic of the second user, the controller circuit further generating a message that is provided to at least one other user in the user group, the message including information indicating that the first user's changed content consumption characteristic is based on the content consumption characteristic of a second user in the user group.

16. The apparatus of claim 15, further comprising a user interface coupled to the transceiver circuit, and wherein the controller circuit further determines if the input data was generated by a user input from the first user and received through the user interface or if the input data was received from the first user through the transceiver.

17. The apparatus of claim 16, wherein the transceiver circuit provides the message to the at least one other user in the user group based on the controller circuit determining that the input data was generated by user input received through the user interface.

18. The apparatus of claim 16, further comprising a display interface coupled to the controller circuit, the display interface providing the message for display based on determining that the input was received from the first user through the transceiver.

19. The apparatus of claim 18, wherein the controller circuit further determines if the first user has indicated that the received input data is to be ignored and wherein the display interface provides the event message if the user has indicated that the received input data is not to be ignored.

20. The apparatus of claim 18, wherein the controller circuit further determines if the received input data is associated with previous input data from the first user and wherein the display interface provides the event message if the received input data is not associated with the previous input data.

21. The apparatus of claim 15, further including a memory coupled to the controller circuit storing the message generated by the controller circuit.

22. The apparatus of claim 15, wherein the input data includes an indication of a viewing status change of a media program.

23. The apparatus of claim 15, wherein the input data includes at least one of tuning a media program, viral tuning a media program, viewing a program, recommending a program, channel surfing, and channel hopping.

24. The apparatus of claim 23, wherein the input data indicates tuning a channel, wherein the input data that was received through the transceiver circuit from the second user includes an indication that the second user tuned the same channel, and wherein the message generated indicates that the first user has viral tuned the same channel.

25. The apparatus of claim 23, wherein the input signal indicates tuning a channel, wherein the input data that was received through the transceiver circuit from the second user includes an indication that the second user has recommended the same channel, and wherein the message generated indicates that the first user has viral tuned the same channel.

26. The apparatus of claim 15, wherein the transceiver circuit further receives the media program.

27. The apparatus of claim 26, wherein the media program is received over a first network and the data that was received from second user is received over a second network.

28. A networking apparatus comprising:
means for receiving input data, the input data indicating that a first user in a user group has changed a content consumption characteristic;
means for determining if the first user's changed content consumption characteristic is based a content consumption characteristic of a second user in the user group; and
means for generating a message that is provided to at least one other user in the user group, the message including information indicating that the first user's changed content consumption characteristic is based on the content consumption characteristic of the second user in the user group.
